(19) United States
(12) Patent Application Publication
(10) Pub. No.: US 2023/0327248 A1
(43) Pub. Date: Oct. 12, 2023

(54) ELECTROCHEMICAL DEVICE AND ELECTRICAL DEVICE

(71) Applicant: Ningde Amperex Technology Limited, Ningde City, (CN)

(72) Inventors: Xiaofeng Li, Ningde (CN); Peipei Guo, Ningde (CN); Sen Lin, Ningde (CN)

(73) Assignee: Ningde Amperex Technology Limited, Ningde City (CN)

(21) Appl. No.: 18/193,698

(22) Filed: Mar. 31, 2023

(30) Foreign Application Priority Data
Apr. 8, 2022 (CN) 202210364254.6

(51) Int. Cl. H01M 50/188; H01M 50/105; H01M 50/178

(52) U.S. Cl. CPC H01M 50/188; H01M 50/105; H01M 50/178

(57) ABSTRACT

An electrochemical device includes an electrode assembly, a packaging bag accommodating the electrode assembly, and electrode terminals connected to the electrode assembly. The packaging bag includes a first seal edge, a third seal edge, a first sidewall connected to the first seal edge, a second sidewall connected to the third seal edge, and a third sidewall. The first sidewall includes a first section connected to the second sidewall; and an arc-shaped second section connected to the third sidewall and the first section. The first seal edge includes a first hem connected to the first section and a second hem connected to the first hem. The first hem is disposed along the thickness direction of the electrode assembly. The second hem includes a first part and a second part. The second part is connected to the second section and the first part and abuts against the second section.

### CROSS-REFERENCE TO RELATED APPLICATION

The present application claims the benefit of priority from the China Patent Application No. 202210364254.6, filed on Apr. 8, 2022, the disclosure of which is hereby incorporated by reference in its entirety.

### TECHNICAL FIELD

This application relates to the technical field of energy storage, and in particular, to an electrochemical device and an electrical device.

### BACKGROUND

With the development of electronic products, the shapes of batteries are increasingly diversified, and a variety of special-shaped batteries have appeared. A special-shaped battery is a battery of a non-rectangular structure viewed from a thickness direction of the battery. Currently, edges of the batteries are sealed rectangularly. For a special-shaped battery, the rectangular edges take up much space and affect an energy density of the battery.

### SUMMARY

In view of the fact above, it is necessary to provide an electrochemical device and an electrical device to reduce space occupied by a battery and increase an energy density of the battery.

An embodiment of this application provides an electrochemical device. The electrochemical device includes an electrode assembly, a packaging bag, and electrode terminals. The packaging bag is configured to accommodate the electrode assembly. The electrode terminals are connected to the electrode assembly. The packaging bag includes at least one seal edge. Along a thickness direction of the electrode assembly, a projection of the at least one seal edge includes an arc section. By designing the seal edge as an arc section, the space occupied by the seal edge is reduced, and the energy density of the battery is increased.

Optionally, in some embodiments of this application, the electrode terminals include a first electrode terminal and a second electrode terminal. The at least one seal edge includes a first seal edge and/or a third seal edge. The first electrode terminal and the second electrode terminal extend out of the packaging bag through the third seal edge. The first seal edge is contiguous to the third seal edge, and, along a width direction of the electrode assembly. A distance between the first seal edge and the first electrode terminal is greater than a distance between the first seal edge and the second electrode terminal. Along the thickness direction of the electrode assembly, a projection of the first seal edge includes an arc section.

Optionally, in some embodiments of this application, along the width direction of the electrode assembly, a projection of the arc section along the thickness direction of the electrode assembly is between a projection of the first seal edge along the thickness direction of the electrode assembly and a projection of the second electrode terminal along the thickness direction of the electrode assembly.

Optionally, in some embodiments of this application, the packaging bag includes a first sidewall, a second sidewall, and a third sidewall. The first sidewall is connected to the first seal edge, and the second sidewall is connected to the third seal edge. The third sidewall and the second sidewall are disposed opposite to each other along a length direction of the electrode assembly. The first sidewall includes a first section and a second section. The first section is connected to the second sidewall and the second section, and the second section is connected to the third sidewall. The second section is arc-shaped. The first seal edge includes a first hem and a second hem. The first hem is connected to the first section. The first hem is disposed along the thickness direction of the electrode assembly and abuts against the first section. The second hem is connected to the first hem. The second hem includes a first part and a second part. The second part is connected to the second section and the first part and abuts against the second section. With the second part stacked between the second section and the first part, the width of the second hem in a second direction is reduced, and in turn, the space occupied by the electrochemical device is reduced, and the energy density of the electrochemical device is increased. In addition, the second hem is designed as a two-layer structure, thereby reducing the probability that the second hem is wrinkled and the seal is broken when the second hem is bent.

Optionally, in some embodiments of this application, a projection of the first part along a width direction of the electrode assembly at least partly overlaps a projection of the second part along the width direction of the electrode assembly.

Optionally, in some embodiments of this application, a projection of the first part along a width direction of the electrode assembly covers a projection of the second part along the width direction of the electrode assembly.

Optionally, in some embodiments of this application, along a width direction of the electrode assembly, a projection of the second hem is located within a projection of the second section.

Optionally, in some embodiments of this application, a length of a projection of the second hem along the length direction of the electrode assembly is greater than a length of a projection of the first hem along the length direction of the electrode assembly.

Optionally, in some embodiments of this application, the electrode assembly is of a structure including at least one of a jelly-roll structure or a stacked structure.

An embodiment of this application further provides an electrical device, including the electrochemical device according to any embodiment described above.

### BRIEF DESCRIPTION OF DRAWINGS

FIG. 1 is a schematic structural diagram of an electrochemical device according to some embodiments;

FIG. 2 is a schematic structural diagram of an electrochemical device after a first seal edge and a second seal edge are bent according to some embodiments of this application;

FIG. 3 is a schematic structural diagram of an electrochemical device after a first seal edge and a second seal edge are bent from another viewing angle according to some embodiments;

FIG. 4 is a schematic structural diagram of the electrochemical device shown in FIG. 3 after a second hem and a fourth hem are bent;

FIG. 5 is a schematic structural diagram of an electrochemical device after a second hem and a fourth hem are bent from another viewing angle according to some embodiments;

FIG. 6 is a schematic structural diagram of an electrochemical device after a second hem and a fourth hem are bent from still another viewing angle according to some embodiments; and

FIG. 7 is a schematic structural diagram of an electrical device according to some embodiments.

### REFERENCE NUMERALS OF MAIN COMPONENTS

Electrochemical device 100
Arc section 100a, 100b
Electrode assembly 10
Package 20
Body portion 20a
First housing 201
First extension portion 201a
Second housing 202
Second extension portion 202a
First sidewall 21
First section 211
Second section 212
Second sidewall 23
Third sidewall 25
Fourth sidewall 27
Third section 271
Fourth section 272
First surface 28
Second surface 29
Edge sealing portion 20b
First seal edge 22
First hem 221
First lateral edge 2211
Second hem 222
Second lateral edge 2221
First part 222a
Second part 222b
Second seal edge 24
Third hem 241
Third lateral edge 2411
Fourth hem 242
Fourth lateral edge 2421
Third part 242a
Fourth part 242b
Third seal edge 26
Electrode terminal 30
First electrode terminal 31
Second electrode terminal 32
Electrical device 200
First direction X
Second direction Y
Third direction Z

The following specific embodiments are intended to describe this application in further detail with reference to the drawings.

### DETAILED DESCRIPTION

The following describes the technical solutions in some embodiments of this application with reference to the drawings hereof. Evidently, the described embodiments are merely a part of but not all of the embodiments of this application.

A component considered to be “disposed on” another component may be directly disposed on the other component or may be disposed on the other component through an intermediate component. A component considered to be “connected to” another component may be directly connected to the other component or may be connected to the other component through an intermediate component. A component considered to “abut against” another component may be at most 3 mm apart from the other component in a thickness direction of a battery cell.

Unless otherwise defined, all technical and scientific terms used herein bear the same meanings as what is normally understood by a person skilled in the technical field of this application. The terms used in the specification of this application are merely intended to describe specific embodiments but not to limit this application. The term “and/or” used herein is intended to include any and all combinations of one or more relevant items recited.

Understandably, when the two components are arranged parallel or perpendicular to each other, an angle may exist between the two components at a tolerance of 0% to ±5%. For example, when a tolerance of an angle between two vertically arranged components exists, one of the components tilts closer to or farther away from the other, and the tolerance of the angle between the two components is greater than 0° and less than or equal to 4.5°.

An embodiment of this application provides an electrochemical device. The electrochemical device includes an electrode assembly, a packaging bag, and electrode terminals. The packaging bag is configured to accommodate the electrode assembly. The electrode terminals are connected to the electrode assembly. The packaging bag includes at least one seal edge. Along a thickness direction of the electrode assembly, a projection of the at least one seal edge includes an arc section. By designing the seal edge as an arc section, the space occupied by the seal edge is reduced, and the energy density of the battery is increased. An arc section used in this disclosure means a part of a circumference of a curved edge. The arc section may correspond to one or more radiuses. As an example, the arc section may be an edge formed of a plurality of arcs with different radiuses. Understandably, the arc section of the seal edge varies depending on the specific shape of the battery cell accommodated. The arc section of the seal edge is configured to fit the shape of a battery cell part corresponding to the arc section. For example, the shape of the arc section of the seal edge is consistent or substantially consistent with the shape of a corner part that is of the battery cell and that is close to the arc section, so as to maximize the fit between the corner part and the arc section.

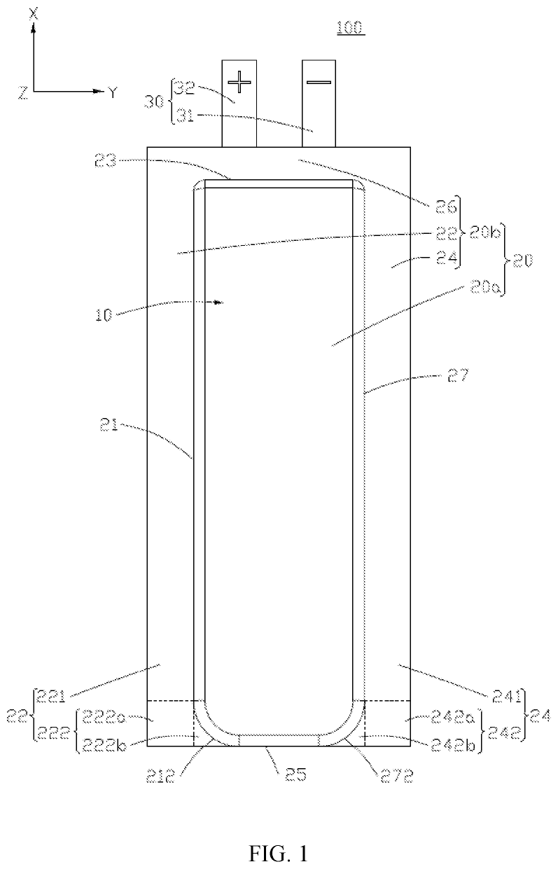

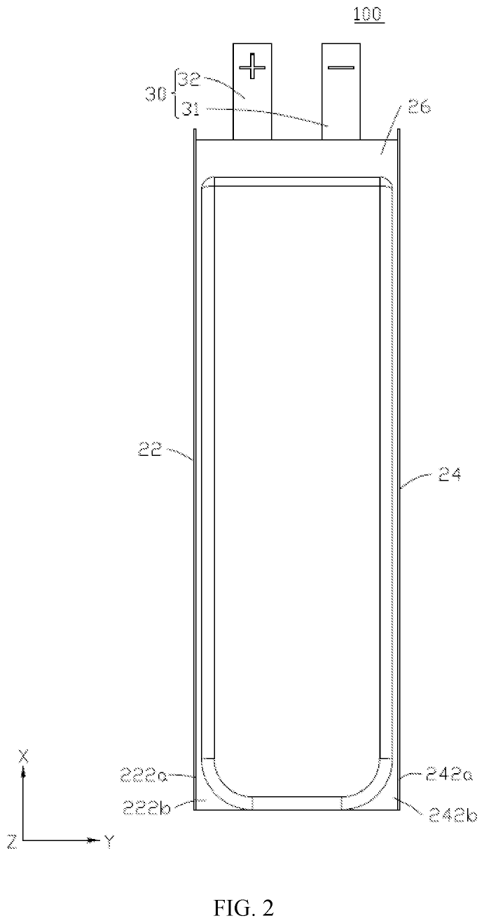

Referring to FIG. 1 and FIG. 2, an embodiment of this application provides an electrochemical device 100, including an electrode assembly 10, a packaging bag 20, and electrode terminals 30. The electrode assembly 10 is disposed in the packaging bag 20. The electrode terminals 30 are connected to the electrode assembly 10, and extend out of the packaging bag through the packaging bag 20.

In an embodiment, the electrode assembly 10 includes a jelly-roll structure formed by winding a positive electrode plate, a negative electrode plate, and a separator. In some other embodiments, the electrode assembly 10 may be a stacked structure instead, in which the positive electrode plate, the separator, and the negative electrode plate are stacked in sequence to form an electrode assembly unit, and then a plurality of electrode assembly units are stacked to form an electrode assembly 10. Optionally, along the thickness direction of the electrode assembly 10, a projection part of the electrode assembly 10 is arc-shaped. That is, the electrode assembly 10 possesses an arc face.

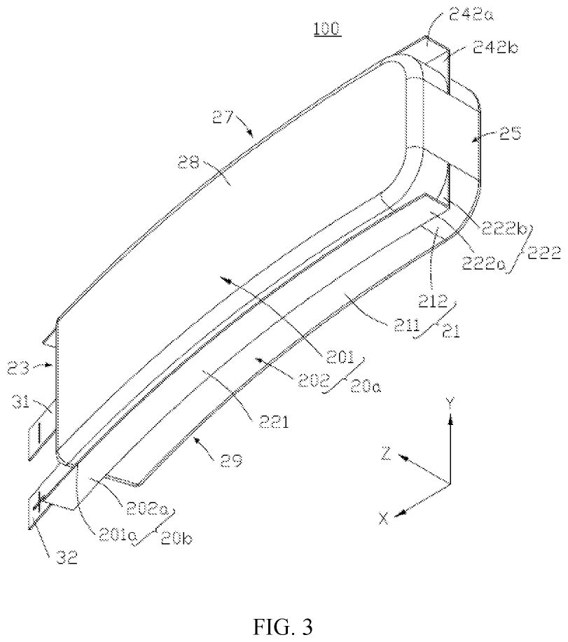

Referring to FIG. 3, in an embodiment, the packaging bag 20 includes a body portion 20a and a seal edge portion 20b connected to the body portion 20a. The electrode assembly 10 is disposed in the body portion 20a, and the seal edge portion 20b seals the body portion 20a. Optionally, the packaging bag 20 includes an aluminum plastic film.

In an embodiment, the body portion 20a includes a first housing 201 and a second housing 202. At least one of the first housing 201 and the second housing 202 is equipped with a groove configured to hold the electrode assembly 10 in place. Optionally, both the first housing 201 and the second housing 202 are equipped with grooves, and the electrode assembly 10 is held in the grooves. The first housing 201 is connected to the second housing 202. The first housing 201 and the second housing 202 may be folded along a junction in between. In this way, the first housing 201 and the second housing 202 are connected to form the body portion 20a to house the electrode assembly 10. A rim the first housing 201 extends outward to form a plurality of first extension portions 201a. A rim of the second housing 202 extends outward to form a plurality of second extension portions 202a. After the first housing 201 and the second housing 202 are folded along the junction in between, the first extension portions 201a coincide with and are hermetically connected to the second extension portions 202a to form an edge seal portion 20b.

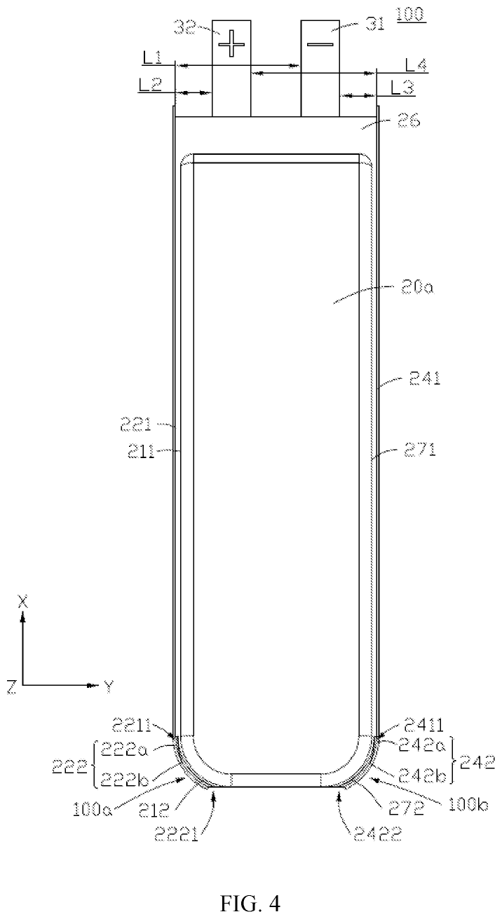

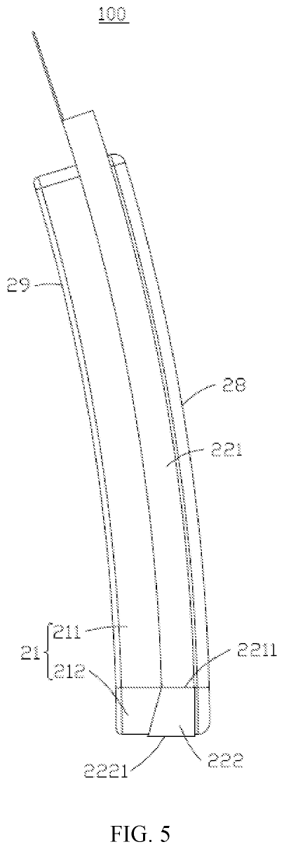

Referring to FIG. 1, FIG. 3, FIG. 4, and FIG. 5, the body portion 20a includes a first sidewall 21, a second sidewall 23, and a third sidewall 25. The first sidewall 21 is connected to the second sidewall 23 and the third sidewall 25. The third sidewall 25 and the second sidewall 23 are disposed opposite to each other along a first direction X. The electrode terminals 30 extend out of the packaging bag through the second sidewall 23. The body portion 20a further includes a fourth sidewall 27. The fourth sidewall 27 is connected to the second sidewall 23 and the third sidewall 25. The first sidewall 21 and the fourth sidewall 27 are disposed opposite to each other along a second direction Y. The second direction Y is perpendicular to the first direction X. The second direction Y is a width direction of the electrode assembly.

In an embodiment, the body portion 20a further includes a first surface 28 and a second surface 29. The second surface 29 and the first surface 28 are disposed opposite to each other along the thickness direction of the electrode assembly 10. A rim of the first surface 28 is connected to the first sidewall 21, the second sidewall 23, the third sidewall 25, and the fourth sidewall 27. A rim of the second surface 29 is connected to the first sidewall 21, the second sidewall 23, the third sidewall 25, and the fourth sidewall 27. Optionally, the first surface 28 and the second surface 29 are arc faces. Optionally, the electrode assembly 10 includes an arc structure bent along the first direction X.

In an embodiment, the electrode terminals 30 include a first electrode terminal 31 and a second electrode terminal 32. Of the first electrode terminal 31 and the second electrode terminal 32, one is a positive terminal, and the other is a negative terminal. Optionally, the electrode terminals 30 may include one first electrode terminal 31 and a plurality of second electrode terminals 32. Optionally, the electrode terminals 30 may include one second electrode terminal 32 and a plurality of first electrode terminals 31. Optionally, the electrode terminals 30 may include a plurality of first electrode terminals 31 and a plurality of second electrode terminals 32.

In an embodiment, the seal edge portion 20b includes a first seal edge 22 and a third seal edge 26. The first seal edge 22 is connected to the first sidewall 21. The third seal edge 26 is connected to the second sidewall 23. The first seal edge 22 is contiguous to the third seal edge 26. Optionally, the first seal edge 22 protrudes from the first sidewall 21 along the first direction X, and is connected to the third seal edge 26. The first electrode terminal 31 and the second electrode terminal 32 extend out of the packaging bag through the third seal edge 26. A vertical distance L1 between the first seal edge 22 and the first electrode terminal 31 is greater than a vertical distance L2 between the first seal edge 22 and the second electrode terminal 32. A third direction Z is defined as a thickness direction of the electrode assembly 10. The third direction Z is perpendicular to the first direction X and the second direction Y. Along the third direction Z, a projection of the first seal edge 22 includes an arc section 100a. That is, the first seal edge 22 possesses an arc face extending along the third direction Z. Optionally, along the second direction Y, a projection of the arc section 100a in the third direction Z is located between a projection of the first seal edge 22 in the third direction Z and a projection of the second electrode terminal 32 in the third direction Z. By designing a part of the first seal edge 22 as an arc face, the space occupied by the first seal edge 22 is reduced, and the energy density of the battery is increased.

The first sidewall 21 includes a first section 211 and a second section 212. One end of the first section 211 is connected to the second sidewall 23, and the other end is connected to the second section 212. One end that is of the second section 212 and that is away from the first section 211 is connected to the third sidewall 25. The second section 212 is arc-shaped. The first seal edge 22 includes a first hem 221 and a second hem 222. The first hem 221 is connected to the first section 211. The second hem 222 is connected to the first hem 221 and the second section 212. Along the second direction Y, a projection of the second hem 222 is located within a projection of the second section 212. Along the third direction Z, the projection of the second hem 222 includes an arc section 100a. The second hem 222 includes a first part 222a and a second part 222b. Optionally, along the third direction Z, the projections of both the first part 222a and the second part 222b include the arc section 100a. The first part 222a is connected to the first hem 221, and the second part 222b is connected to the second section 212 and the first part 222a. Along the second direction Y, a length of a projection of the second hem 222 in the first direction X is greater than a length of a projection of the first hem 221 in the first direction X. Specifically, referring to FIG. 4 to FIG. 6, viewed along the first direction X, the first hem 221 includes a first lateral edge 2211. The first lateral edge 2211 is connected to the second hem 222. The second hem 222 includes a second lateral edge 2221 existent on a side away from the first hem 221. A length of the second lateral edge 2221 along the third direction Z is greater than a length of the first lateral edge 2211 along the third direction Z. By bending the first seal edge 22, the width of the electrochemical device 100 along the second direction Y is reduced. Optionally, the first hem 221 is bent along the third direction Z and abuts against the first section 211. The first hem 221 and the first part 222a are structured in one piece. The first hem 221 drives the first part 222a to bend synchronously along the third direction Z. Along the third direction Z, the second part 222b is bent along a direction opposite to the bending direction of the first part 222a, and abuts against the second section 212, so that the second part 222b is stacked between the second section 212 and the first part 222a. After the first hem 221 and the second hem 222 are bent, along the second direction Y, a projection of the first part 222a at least partly overlaps a projection of the second part 222b. Optionally, along the second direction Y, the projection of the first part 222a covers the projection of the second part 222b. With the second part 222b stacked between the second section 212 and the first part 222a, the width of the second hem 222 in the second direction Y is reduced, and in turn, the space occupied by the electrochemical device 100 is reduced, and the energy density of the electrochemical device 100 is increased. In addition, the second hem 222 is designed as a two-layer structure, thereby reducing the probability that the second hem is wrinkled and the seal is broken when the second hem is bent.

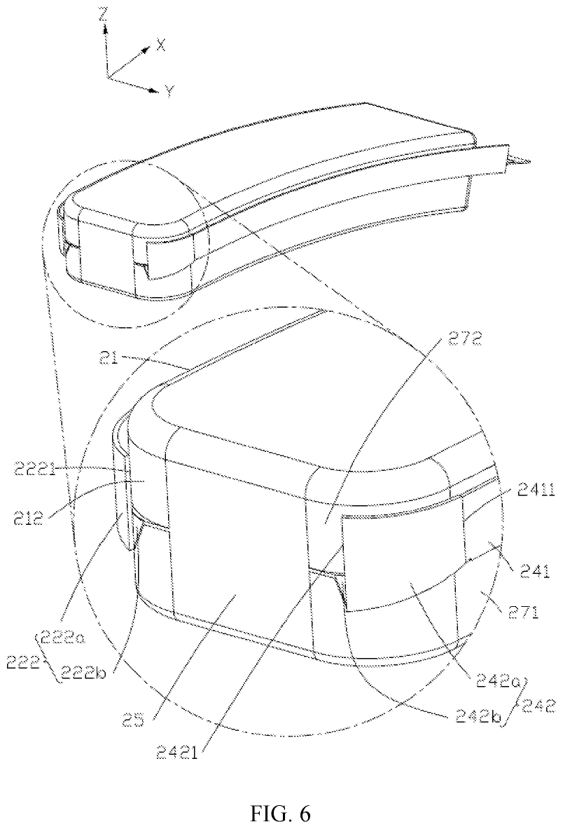

Referring to FIG. 1, FIG. 4, and FIG. 6, the seal edge 20b further includes a second seal edge 24. The second seal edge 24 is connected to the fourth sidewall 27. The second seal edge 24 is contiguous to the third seal edge 26. Optionally, the second seal edge 24 protrudes from the fourth sidewall 27 along the first direction X, and is connected to the third seal edge 26. A vertical distance L3 between the second seal edge 24 and the first electrode terminal 31 is less than a vertical distance L4 between the second seal edge 24 and the second electrode terminal 32. Along the third direction Z, a projection of the second seal edge 24 includes an arc section 100b. That is, the second seal edge 24 possesses an arc face extending along the third direction Z. Optionally, along the second direction Y, a projection of the arc section 100b in the third direction Z is located between a projection of the second seal edge 24 in the third direction Z and a projection of the first electrode terminal 31 in the third direction Z. By designing a part of the second seal edge 24 as an arc face, the space occupied by the second seal edge 24 is reduced, and the energy density of the battery is increased.

The fourth sidewall 27 includes a third section 271 and a fourth section 272. One end of the third section 271 is connected to the second sidewall 23, and the other end is connected to the fourth section 272. One end that is of the fourth section 272 and that is away from the third section 271 is connected to the third sidewall 25. The fourth section 272 is arc-shaped. The second seal edge 24 includes a third hem 241 and a fourth hem 242. The third hem 241 is connected to the third section 271. The fourth hem 242 is connected to the third hem 241 and the fourth section 272. Along the second direction Y, a projection of the fourth hem 242 is located within a projection of the fourth section 272. Along the third direction Z, the projection of the fourth hem 242 includes an arc section 100b. The fourth hem 242 includes a third part 242a and a fourth part 242b. Optionally, along the third direction Z, the projections of both the third part 242a and the fourth part 242b include the arc section 100b. The third part 242a is connected to the third hem 241, and the fourth part 242b is connected to the fourth section 272 and the third part 242a. Along the second direction Y, a length of a projection of the fourth hem 242 in the first direction X is greater than a length of a projection of the third hem 241 in the first direction X. Specifically, referring to FIG. 6, viewed along the first direction X, the third hem 241 includes a third lateral edge 2411. The third lateral edge 2411 is connected to the fourth hem 242. The fourth hem 242 includes a fourth lateral edge 2421 existent on a side away from the third hem 241. A length of the fourth lateral edge 2421 along the third direction Z is greater than a length of the third lateral edge 2411 along the third direction Z. By bending the second seal edge 24, the width of the electrochemical device 100 along the second direction Y is reduced. Optionally, the third hem 241 is bent along the third direction Z and abuts against the third section 271. The third hem 241 and the third part 242a are connected in one piece. The third hem 241 drives the third part 242a to bend synchronously along the third direction Z. Along the third direction Z, the fourth part 242b is bent along a direction opposite to the bending direction of the third part 242a, and abuts against the fourth section 272, so that the fourth part 242b is stacked between the fourth section 272 and the third part 242a. After the third hem 241 and the fourth hem 242 are bent, along the second direction Y, a projection of the third part 242a at least partly overlaps a projection of the fourth part 242b. Optionally, along the second direction Y, the projection of the third part 242a covers the projection of the fourth part 242b. With the fourth part 242b stacked between the fourth section 272 and the third part 242a, the width of the fourth hem 242 in the second direction Y is reduced, and in turn, the space occupied by the electrochemical device 100 is reduced, and the energy density of the electrochemical device 100 is increased. In addition, the fourth hem 242 is designed as a two-layer structure, thereby reducing the probability that the second hem is wrinkled and the seal is broken when the second hem is bent.

In an embodiment, an end that is of the first hem 221 and that is away from the second hem 222 protrudes from the second sidewall 23, and is connected to the third seal edge 26. An end that is of the third hem 241 and that is away from the fourth hem 242 protrudes from the second sidewall 23, and is connected to the third seal edge 26.

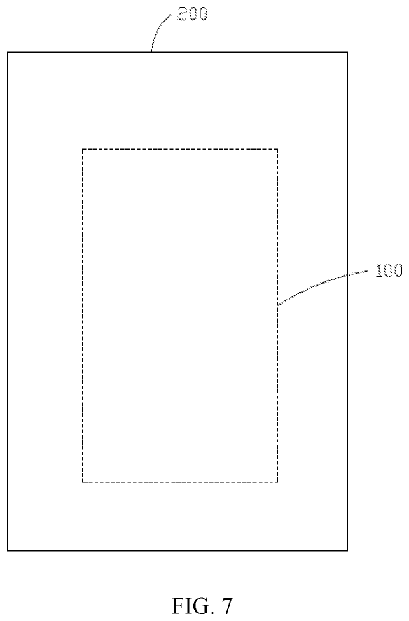

Referring to FIG. 7, this application further provides an electrical device 200 containing the electrochemical device 100. In an embodiment, the electrical device 200 according to this application may be, but without being limited to, a wrist phone, a wrist watch, a wrist health monitor, VR glasses, an unmanned aerial vehicle, or the like.

A person of ordinary skill in the art understands that the foregoing embodiments are merely intended to illustrate this application, but not intended to limit this application. All appropriate modifications and changes made to the embodiments without departing from the spirit and conception of this application still fall within the protection scope of this application.

What is claimed is:

1. An electrochemical device, comprising:
an electrode assembly;
a packaging bag accommodating the electrode assembly; and
electrode terminals connected to the electrode assembly; wherein,
the packaging bag comprises at least one seal edge;
along a thickness direction of the electrode assembly, a projection of the at least one seal edge comprises an arc section;
the at least one seal edge comprises a first seal edge and a third seal edge;
the packaging bag comprises a first sidewall, a second sidewall, and a third sidewall;
the first sidewall is connected to the first seal edge, and the second sidewall is connected to the third seal edge;
the third sidewall and the second sidewall are disposed opposite to each other along a length direction of the electrode assembly;
the first sidewall comprises a first section and a second section;
the first section is connected to the second sidewall and the second section; and the second section is connected to the third sidewall;
the second section is arc-shaped;
the first seal edge comprises a first hem and a second hem; and
the first hem is connected to the first section, the first hem is disposed along the thickness direction of the electrode assembly and abuts against the first section, the second hem is connected to the first hem, the second hem comprises a first part and a second part; and
the second part is connected to the second section and the first part, and abuts against the second section.

2. The electrochemical device according to claim 1, wherein the electrode terminals comprise a first electrode terminal and a second electrode terminal;
the first electrode terminal and the second electrode terminal extend out of the packaging bag through the third seal edge;
the first seal edge is contiguous to the third seal edge;
along a width direction of the electrode assembly, a distance between the first seal edge and the first electrode terminal is greater than a distance between the first seal edge and the second electrode terminal; and
along the thickness direction of the electrode assembly, a projection of the first seal edge comprises an arc section.

3. The electrochemical device according to claim 2, wherein, along the width direction of the electrode assembly, a projection of the arc section along the thickness direction of the electrode assembly is between a projection of the first seal edge along the thickness direction of the electrode assembly and a projection of the second electrode terminal along the thickness direction of the electrode assembly.

4. The electrochemical device according to claim 1, wherein a projection of the first part along a width direction of the electrode assembly at least partly overlaps a projection of the second part along the width direction of the electrode assembly.

5. The electrochemical device according to claim 1, wherein a projection of the first part along a width direction of the electrode assembly covers a projection of the second part along the width direction of the electrode assembly.

6. The electrochemical device according to claim 1, wherein, along a width direction of the electrode assembly, a projection of the second hem is located within a projection of the second section.

7. The electrochemical device according to claim 1, wherein a length of a projection of the second hem along the length direction of the electrode assembly is greater than a length of a projection of the first hem along the length direction of the electrode assembly.

8. The electrochemical device according to claim 1, wherein the electrode assembly is of a structure comprising at least one of a jelly-roll structure or a stacked structure.

9. An electrical device, wherein the electrical device comprises the electrochemical device according to claim 1.

10. The electrical device according to claim 9, wherein the electrode terminals comprise a first electrode terminal and a second electrode terminal;
the first electrode terminal and the second electrode terminal extend out of the packaging bag through the third seal edge;
the first seal edge is contiguous to the third seal edge, and, along a width direction of the electrode assembly, a distance between the first seal edge and the first electrode terminal is greater than a distance between the first seal edge and the second electrode terminal;
along the thickness direction of the electrode assembly, a projection of the first seal edge comprises an arc section.

11. The electrical device according to claim 10, wherein, along the width direction of the electrode assembly, a projection of the arc section along the thickness direction of the electrode assembly is between a projection of the first seal edge along the thickness direction of the electrode assembly and a projection of the second electrode terminal along the thickness direction of the electrode assembly.

12. The electrical device according to claim 9, wherein, a projection of the first part along a width direction of the electrode assembly at least partly overlaps a projection of the second part along the width direction of the electrode assembly.

13. The electrical device according to claim 9, wherein, along a width direction of the electrode assembly, a projection of the second hem is located within a projection of the second section.

14. The electrical device according to claim 9, wherein the electrode assembly is of a structure comprising at least one of a jelly-roll structure or a stacked structure.
